(19) United States
(12) Patent Application Publication
(10) Pub. No.: US 2011/0181570 A1
(43) Pub. Date: Jul. 28, 2011

(54) DISPLAY APPARATUS, DISPLAY PANEL DRIVER AND DISPLAY PANEL DRIVING METHOD

(75) Inventor: Tadao MINAMI, Kanagawa (JP)

(73) Assignee: RENESAS ELECTRONICS CORPORATION

(21) Appl. No.: 13/009,115

(22) Filed: Jan. 19, 2011

(30) Foreign Application Priority Data
Jan. 25, 2010 (JP) 2010-013069

(51) Int. Cl. G06F 3/038

(52) U.S. Cl. 345/209

(57) ABSTRACT

A display apparatus is provided with: a display panel including a data electrode; a display panel driver driving the data electrode by supplying a data signal to the data electrode; and a controller supplying a polarity switching signal specifying a polarity of the data signal to the display panel driver. Control data are incorporated into the polarity switching signal, and the display panel driver operates in responsive to the control data.

### INCORPORATION BY REFERENCE

This application claims the benefit of priority based on Japanese Patent Application No. 2010-013069, filed on Jan. 25, 2010, the disclosure of which is incorporated herein by reference.

### BACKGROUND OF THE INVENTION

1. Field of the Invention

The present invention relates to a display apparatus, a display panel driver and a display panel driving method, and more particularly relates to supply of control data to a display panel driver.

2. Description of the Related Art

Recent data electrode driver circuits of display panels (such as a liquid crystal display panel) are often equipped with various advanced functions. Examples of advanced functions of the data electrode driver circuit include shift direction switching of a shift register within the data electrode driver circuit, drive capacity switching of output amplifiers, input data inversion. Signals for controlling such functions are externally fed to an inner logic of a data side drive circuit from an external component.

Japanese Patent Application Publication No. P2002-215108 A discloses a conventional configuration of the data electrode driver circuit supporting advanced functions. FIG. 1 is a block diagram showing the configuration of the liquid crystal display apparatus disclosed in this gazette. The liquid crystal display apparatus in FIG. 1 is provided with a liquid crystal display panel 1, a control circuit 2, a gray-level generator power supply 3, a common power source 4, a data electrode driver circuit 5 and a scan electrode driver circuit 6.

The liquid crystal display panel 1 may be an active matrix color liquid crystal display panel that incorporates thin film transistors (TFTs) as switching elements. In the liquid crystal display panel 1, pixels are provided in respective regions surrounded with scan electrodes (gate lines) arranged at predetermined intervals and extended in the horizontal direction and data electrodes (source lines) arranged at predetermined intervals in the vertical direction. Each pixel of the liquid crystal display panel 1 incorporates a liquid crystal cell that equivalently serves as a capacitive load, a common electrode, a TFT driving the corresponding liquid crystal cell, and a capacitor for accumulating data charges for one vertical synchronization period. When the liquid crystal display panel 1 is driven, data signals generated in response to red data DR, green data DG and blue data DB of digital image data are applied to the corresponding data electrodes, and scan signals generated in response to a horizontal synchronization signal S_{H} and a vertical synchronization signal S_{V} are sequentially applied to the corresponding scan electrodes, in a state in which the common electrode is fixed to a common voltage level Vcom. Consequently, color characters and pictures are displayed on the liquid crystal display panel 1.

The control circuit 2, which may be constituted as an ASIC (Application Specific Integrated Circuit), for example, converts the red data DR, the green data DG and the blue data DB, which are externally supplied 6-bit data, into display data D00 to D05, D10 to D15 and D20 to D25, each having a bit width of 18 bits, to supply to the data electrode driver circuit 5. In detail, 18 signal lines associated with the respective bits of the display data D00 to D05, D10 to D15 and D20 to D25 are connected between the control circuit 2 and the data electrode driver circuit 5. The display data D00 to D05, D10 to D15 and D20 to D25 are sent through the 18 signal lines to the data electrode driver circuit 5.

The control circuit 2 also supplies a strobe signal STB, a clock signal CLK, a horizontal start pulse signal STH, a polarity switching signal POL, a vertical start pulse STV and a data inversion signal INV which are generated in response to a dot clock DCLK, the horizontal synchronization signal S_{H} and the vertical synchronization signal S_{V}, to the gray-level generator power supply 3, the common power source 4, the data electrode driver circuit 5 and the scan electrode driver circuit 6. The strobe signal STB is a signal of the same cycle period as the horizontal synchronization signal S_{H}. Also, the clock signal CLK, which may have a frequency equal to or different from the dot clock DCLK, is used to generate sampling pulses SP1 to SP176 from the horizontal start pulse signal STH in a shift register within the data electrode driver circuit 5. The horizontal start pulse signal STH has the same cycle period as the horizontal synchronization signal S_{H} and is generated by delaying the strobe signal STB by a certain delay time corresponding to several pulses of the clock signal CLK.

The polarity switching signal POL specifies the polarities of the respective data signals fed to the respective data electrodes and is inverted to achieve inversion drive of the liquid crystal display panel 1, for example, every horizontal synchronization period (namely, for every one horizontal line). The polarity switching signal POL is also inverted every vertical synchronization period. It should be noted that the polarity switching signal is widely used in liquid crystal display apparatuses, and a liquid crystal display apparatus that uses the polarity switching signal is disclosed in, for example, Japanese Patent Application Publication No. P2006-180119 A. The vertical start pulse STV has the same cycle period as the vertical synchronization signal SV. Also, the data inversion signal INV is a control signal that indicates whether the bits of each display data D00 to D05, D10 to D15 and D20 to D25 are inverted from the original bits of the same. As described later, the data inversion signal INV is used to reduce the electric power consumption of the control circuit 2.

The gray-level generator power supply 3 supplies gray-level reference voltages V_{I1} to V_{I9}, which are set so as to achieve gamma correction, to the data electrode driver circuit 5. The signal levels of the gray-level reference voltages V_{I1} to V_{I9} are switched between the positive and negative polarities with respect to the common level Vcom (the potential of the common electrode of the liquid crystal display panel 1), for every horizontal line, in response to the polarity switching signal POL.

Next, a detailed description is given of the data electrode driver circuit 5. In this example, the resolution of the liquid crystal display panel 1 is 176×220 pixels. Each pixel is provided with three sub-pixels of red (R), green (G) and blue (B) and therefore the number of the sub-pixels is 528×220 pixels. The data electrode driver circuit 5 is provided with a shift register 12, a data buffer 13, a data register 14, a control circuit 15, a data latch circuit 16, a gray-level voltage generator circuit 17, a gray-level voltage selector circuit 18 and an output circuit 19, as shown in FIG. 2.

The shift register 12 is a serial-in-parallel-out shift register composed of 176 D-flipflops. The shift register 12 carries out a shift operation of the horizontal start pulse signal STH received from the control circuit 2 across the 176 D-flipflops in synchronization with the clock signal CLK received from the control circuit 2, to thereby generate 176 parallel sampling pulses SP1 to SP176.

The data buffer 13 transfers the display data D00 to D05, D10 to D15 and D20 to D25 received from the control circuit 2 to the data register 14. Here, the display data transferred to the data register 14 are denoted by numerals D′00 to D′05, D′10 to D′15 and D′20 to D′25, hereinafter.

The data register 14 includes 176 18-bit latches which receive the display data D′00 to D′05, D′10 to D′15 and D′20 to D′25 from the data buffer 13 in synchronization with the sampling pulses SP1 to SP176, respectively.

The control circuit 15 generates a strobe signal STB₁ and a control signal SWA in response to the strobe signal STB and the polarity switching signal POL.

The data latch circuit 16 simultaneously latches the display data from the data register 14 in response to assertion of the strobe signal STB₁, and transfers the latched display data to the gray-level voltage selector circuit 18.

The gray-level voltage selector circuit 18 selects a corresponding gray-level voltage from the 64 gray-level voltages generated by the gray-level voltage generator circuit 17 for each of the display data received from the data latch circuit 16, and supplies the selected gray-level voltages to the output circuit 19. The 64 gray-level voltages generated by the gray-level voltage generator circuit 17 are controlled by the gray-level reference voltages V_{I1} to V_{I9}.

The output circuit 19 generates data signals that have the voltage levels corresponding to the gray-level voltages received from the gray-level voltage selector circuit 18 and supplies the generated data signals to the data electrodes connected to the data signal outputs S1 to S528.

FIG. 3 is a timing chart showing exemplary operations of the control circuit 2, the gray-level generator power supply 3, the common power source 4 and the data electrode driver circuit 5 in the liquid crystal display apparatus 1.

The control circuit 2 supplies the clock signal CLK, the strobe signal STB, the horizontal start pulse signal STH, the polarity switching signal POL and the data inversion signal INV to the data electrode driver circuit 5. The strobe signal STB is asserted at beginning of each horizontal synchronization period. As described above, the horizontal start pulse signal STH is asserted with a delay of the time period corresponding to several pulses of the clock signal CLK from the strobe signal STB. The polarity switching signal POL is inverted at the beginning of each horizontal synchronization period. Consequently, the shift register 12 in the data electrode driver circuit 5 carries out the shift operation for shifting the horizontal start pulse signal STH in synchronization with the clock signal CLK to sequentially generate the 176 parallel sampling pulses SP1 to SP176.

Meanwhile, the control circuit 2 converts the red data DR, the green data DG and the blue data DB, which are six bit data, into the display data D00 to D05, D10 to D15 and D20 to D25, which are 18-bit data, to supply to the data electrode driver circuit 5. Consequently, the display data D00 to D05, D10 to D15 and D20 to D25 are supplied as the display data D′00 to D′05, D′10 to D′15 and D′20 to D′25 to the data register 14 after being held in the data buffer 13 in the data electrode driver circuit 5 for a time period corresponding to one pulse of the clock signal CLK1, which is generated by delaying the clock signal CLK by delayed by a predetermined time.

The display data D′00 to D′05, D′10 to D′15 and D′20 to D′25 are sequentially latched by the data register 14 in synchronization with the sampling pulses SP1 to SP176 supplied by the shift register 12, and then simultaneously latched by the data latch circuit 16 in synchronization with the pull-up of the strobe signal STB1. The display data D′00 to 0′05, D′10 to D′15 and D′20 to D′25 latched by the data latch circuit 16 held therein for one horizontal synchronization period. In response to the display data latched by the data latch circuit 16, the gray-level voltage selector circuit 18 and the output circuit 19 supply the data signals to the respective data electrodes connected to the outputs S₁ to S₅₂₈.

Here, the control circuit 2 has a function of transferring the display data to the data electrode driver circuit 5 with the respective bits of the display data invert from the original display data, and asserting the data inversion signal INV in a case where the display data are inverted. On the other hand, the data buffer 13 in the data electrode driver circuit 5 has a function of inverting the respective bits of the display data received from the control circuit 2 in response to the data inversion signal INV upon transferring the display data to the data register 14. In detail, when the data inversion signal INV is negated, the data buffer 13 supplies the display data D00 to D05, D10 to D15 and D20 to D25 in their original states, as the display data D′00 to D′05, D′10 to D′15 and D′20 to D′25 to the data register 14. On the other hand, when the data inversion signal INV is asserted, the data buffer 13 inverts the respective bits of the display data D00 to D05, D10 to D15 and D20 to D25 and supplies the inverted display data to the data register 14 as the display data D′00 to D′05, D′10 to D′15 and D′20 to D′25.

Such function aims to reduce the electric power required to transfer the display data D00 to D05, D10 to D15 and D20 to D25 from the control circuit 2 to the data electrode driver circuit 5. In general, the signal lines have a parasitic capacitance, and thus electric power is consumed to charge the parasitic capacitances when the voltage levels of the signal lines used to send the display data D00 to D05, D10 to D15 and D20 to D25 are switched. Hence, the electric power consumption can be reduced by avoiding switching the voltage levels of the signal lines used to send the display data D00 to D05, D10 to D15 and D20 to D25. In order to achieve this, the respective bits of the display data currently transferred are compared with those of the preceding display data, and, if the number of the inverted bits is larger than a predetermined value, the display data are transferred with the respective bits thereof inverted. The original display data can be restored in the data buffer 13 in the data electrode driver circuit 5 by inverting the inverted display data again.

In a case where the display data D00 to D05, D10 to D15 and D20 to D25 of all 0 are currently to be sent to the data electrode driver circuit 5 and the preceding display data D00 to D05, D10 to D15 and D20 to D25 are all 1, the current display data D00 to D05, D10 to D15 and D20 to D25 are inverted to all 1 with the data inversion signal INV asserted. The data buffer 13 in the data electrode driver circuit 5 supplies the data generate by inverting the display data D00 to D05, D10 to D15 and D20 to D25 to the data register 14 as the display data D′00 to D′05, D′10 to D′15 and D′20 to D′25, in response to the assertion of the data inversion signal INV. This allows transferring the original display data D00 to D05, D10 to D15 and D20 to D25 of all 0 to the data electrode driver circuit 5, while reducing the power consumption necessary for the data transfer.

One issue caused by the advanced functions of the data electrode driver circuit is the increase in the number of the required input terminals used to feed the control signals, which results in the increase in the chip area. As mentioned above, it is necessary to externally supply additional control signals to the data electrode driver circuit, in order to provide various advanced functions for the data electrode driver circuit in the panel display apparatus, including the switching of the shift direction of the shift register integrated therein, the switching of the drive capacity of the output amplifier and the inversion function of the input display data. If additional signal lines are used to feed additional control signals to the inner logic circuit of the data electrode driver circuit for attaining such advanced functions, dedicated input terminals (or pads) and interconnections are additionally required in the data electrode driver circuit and this may cause an increase in the chip area of the data electrode driver circuit. The increase in the chip area results in the increases in the material cost and the manufacturing cost and is not desirable from the viewpoint of the cost.

### SUMMARY

In an aspect of the present invention, a display apparatus is provided with: a display panel including a data electrode; a display panel driver driving the data electrode by supplying a data signal to the data electrode; and a controller supplying a polarity switching signal specifying a polarity of the data signal to the display panel driver. Control data are incorporated into the polarity switching signal, and the display panel driver operates in responsive to the control data.

In another aspect of the present invention, a display panel driver is provided with: an output circuit receiving a polarity switching signal into which control data are incorporated and supplying a data signal of a polarity specified by the polarity switching signal to a data electrode of a display panel; a logic circuit extracting the control data from the polarity switching signal and generating a control signal from the extracted control data; and an internal circuit operating in response to the control signal.

In still another aspect of the present invention, a display panel driving method includes: supplying a polarity switching signal into which control data are incorporated, to a display panel driver; driving a data electrode of a display panel by an output circuit of the display panel driver, through supplying a data signal of a polarity specified by the polarity switching signal to the data electrode; extracting the control data from the polarity switching signal; and controlling an internal circuit within the display panel driver in response to the control data.

The present invention provides an advance function for a display driver which drives the data electrodes, while avoiding an increase in the number of the input terminals used to supply control signals.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing the configuration of the conventional liquid crystal display apparatus;

FIG. 2 is a block diagram showing the conventional configuration of the data electrode driver circuit in the liquid crystal display apparatus in FIG. 1;

FIG. 3 is a timing chart showing the operation of the data electrode driver circuit shown in FIG. 2;

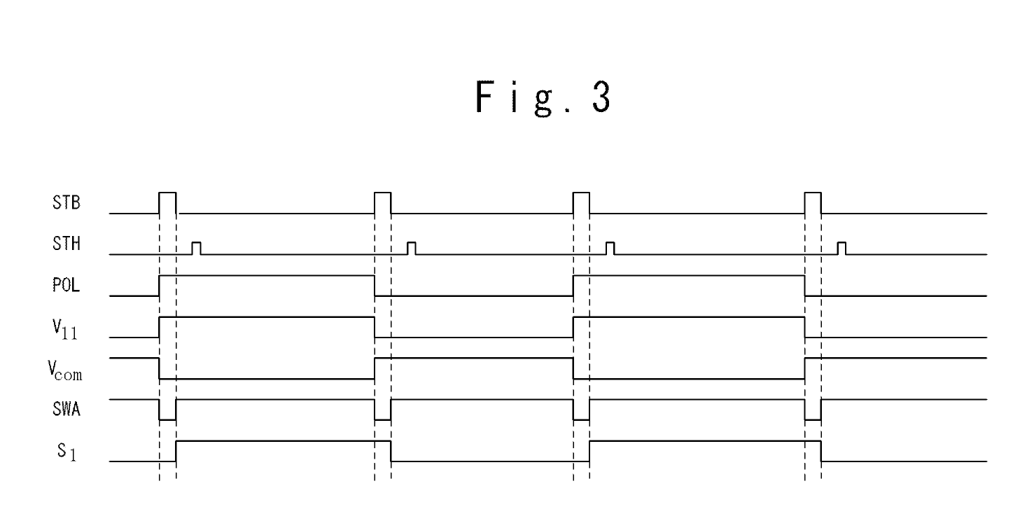

FIG. 4 is a block diagram showing an exemplary configuration of a liquid crystal display apparatus in one embodiment of the present invention;

FIG. 5 is a block diagram showing an exemplary configuration of a data electrode driver circuit in the liquid crystal display apparatus shown in FIG. 4; and

FIG. 6 is a timing chart showing an exemplary operation of the data electrode driver circuit in FIG. 5.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

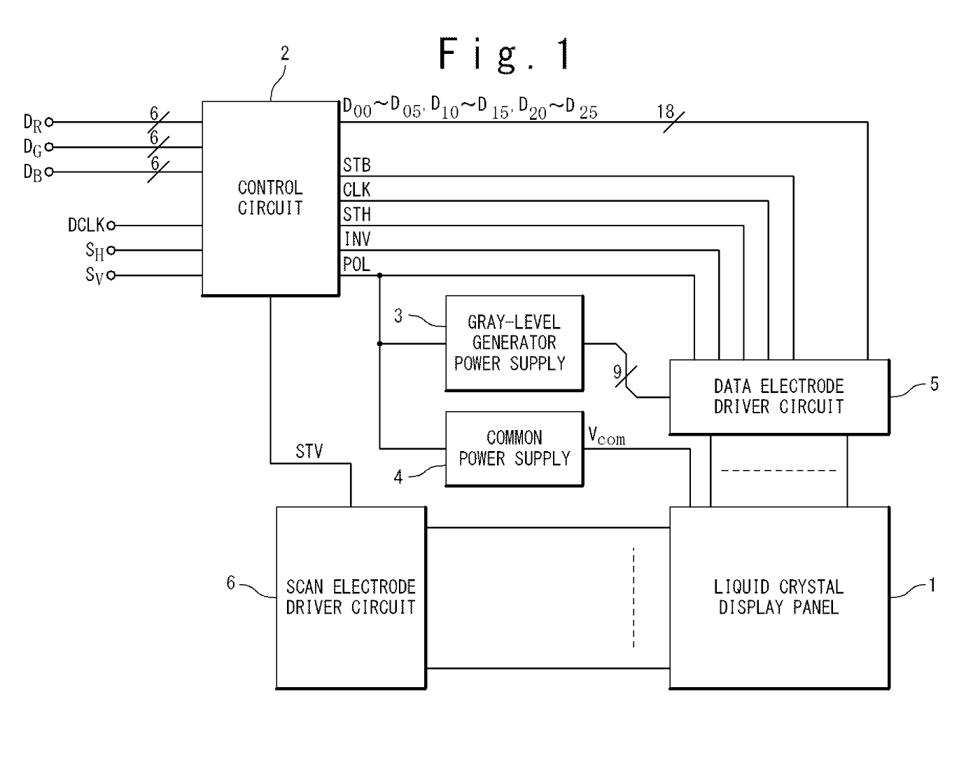

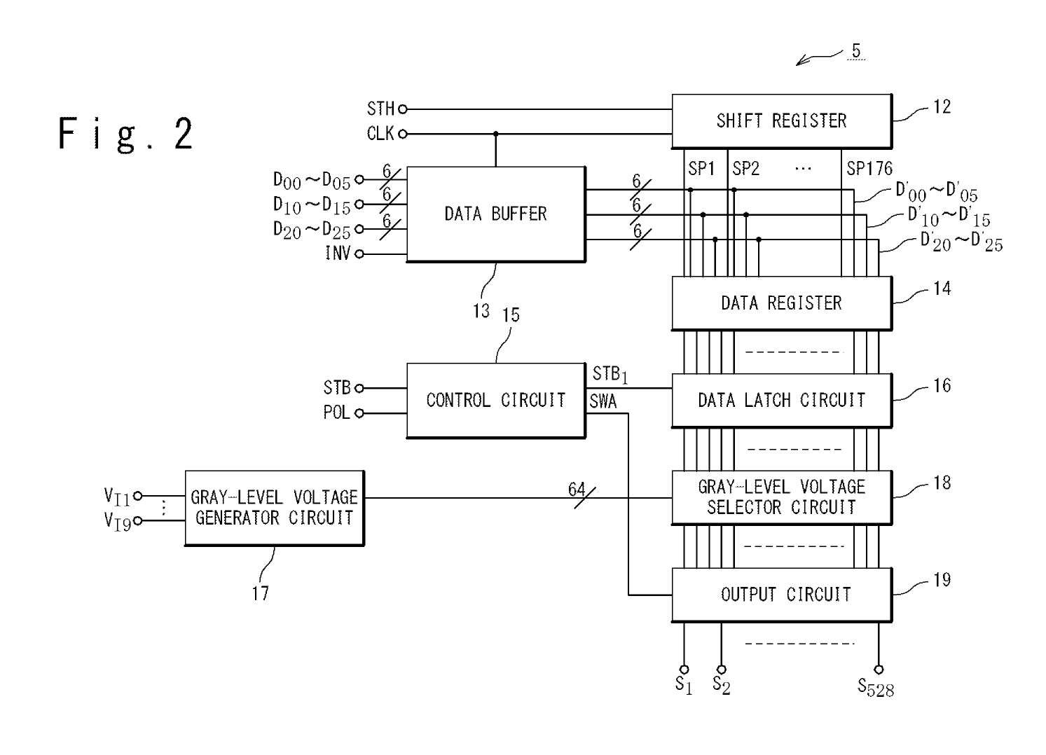

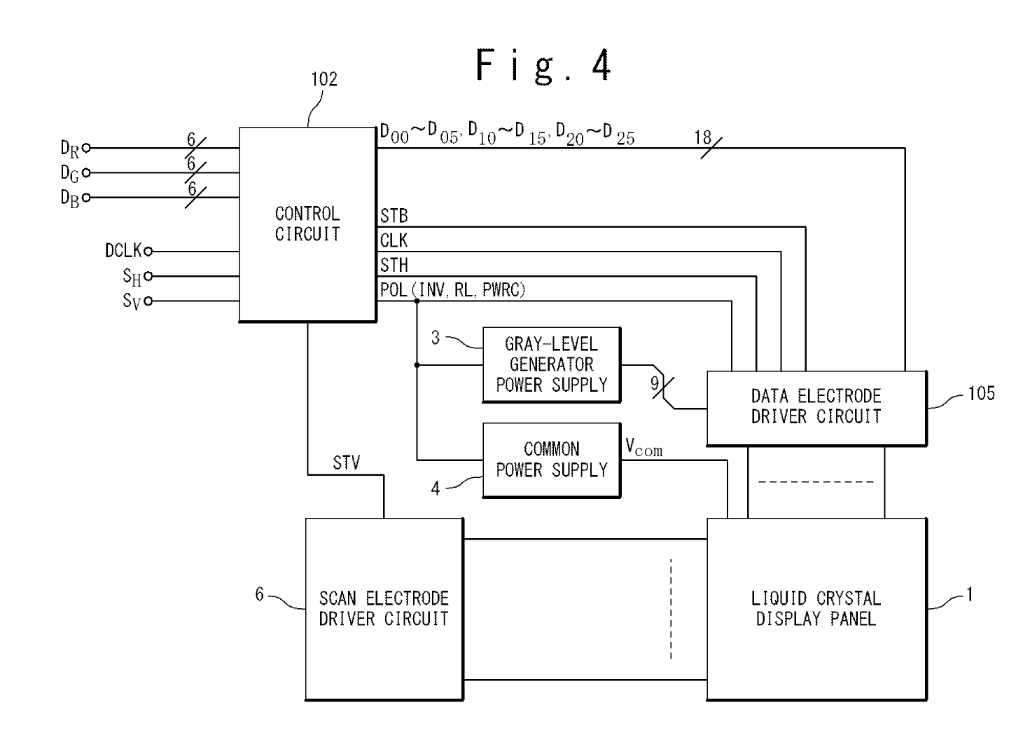

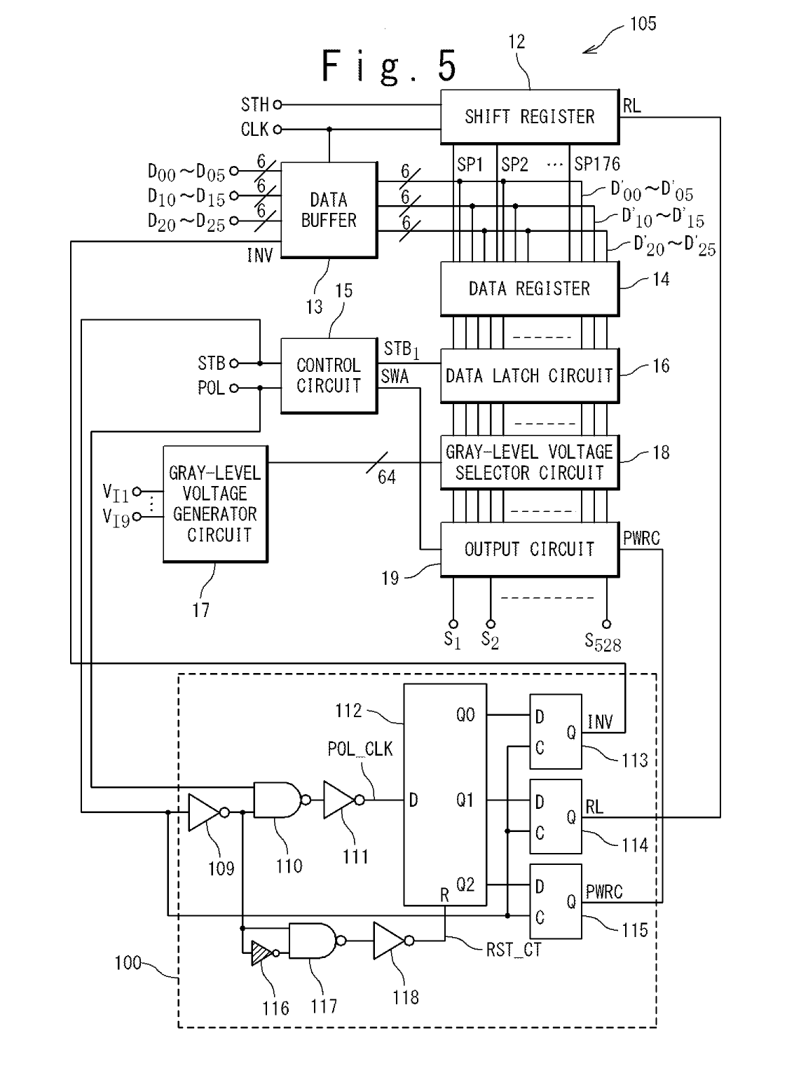

The embodiment of the present invention will be described below with reference to the attached drawings. It should be noted that, in FIGS. 4, 5, same numerals denote elements identical or similar to those in FIGS. 1, 2, and detailed descriptions are not given.

FIG. 4 is a block diagram showing an exemplary configuration of the liquid crystal display apparatus in one embodiment of the present invention. The liquid crystal display apparatus of this embodiment has a configuration in which the control circuit 2 in the liquid crystal display apparatus shown in FIG. 1 is replaced with a control circuit 102, and the data electrode driver circuit 5 is replaced with a data electrode driver circuit 105.

The control circuit 102 supplies the display data D00 to D05, D10 to D15 and D20 to D25, the clock signal CLK, the strobe signal STB, the horizontal start pulse signal STH and the polarity switching signal POL to the data electrode driver circuit 105. The data electrode driver circuit 105 drives the liquid crystal display panel 1 in response to the display data D00 to D05, D10 to D15 and D20 to D25, the clock signal CLK, the strobe signal STB, the horizontal start pulse signal STH and the polarity switching signal POL.

In this embodiment, the polarity switching signal POL sent to the data electrode driver circuit 105 is used not only to specify the polarities of the data signals supplied to the data electrodes in the liquid crystal display panel 1, but also to supply control data used to control the operations of the data electrode driver circuit 105. The control data are sent to the data electrode driver circuit 105 by superimposing the control data into the polarity switching signal POL during the period in which the strobe signal STB is negated (or set low in this embodiment). In this embodiment, the control data are sent to the data electrode driver circuit 105 in the form of the number of the pulses incorporated into the polarity switching signal POL during the period in which the strobe signal STB is set low.

The data electrode driver circuit 105 extracts the control data from the polarity switching signal POL, and decodes the control data to generate the various control signals. The circuits integrated within the data electrode driver circuit 105 are operated in response to the generated control signals. In the following, a description is given of the configuration of the data electrode driver circuit 105 adapted to the above-described operations.

FIG. 5 is a block diagram showing an exemplary configuration of the data electrode driver circuit 105 in this embodiment. The data electrode driver circuit 105 of this embodiment has a configuration in which a decoder logic circuit 100 is added to the data electrode driver circuit 5 shown in FIG. 2. The decoder logic circuit 100 extracts the control data from the polarity switching signal POL, decodes the control data to generate the data inversion signal INV, a shift direction control signal RL and a drive capacity adjustment signal PWRC. The data inversion signal INV is a signal used to control the data buffer 13 as mentioned above; in response to the data inversion signal INV, the data buffer 13 transfers to the data register 14 the display data received from the control circuit 102 with the respective bits thereof unchanged or with all the bits thereof inverted. The shift direction control signal RL is a signal used to control the shift direction switching of the shift direction of the shift register 12. As mentioned above, the shift register 12, which sequentially outputs the 176 parallel sampling pulses SP1 to SP176 as a result of the shift operation of the horizontal start pulse signal STH therein, is adapted to switch the order of the outputs of the sampling pulses SP1 to SP176 by switching the shift direction. The drive capacity adjustment signal PWRC is a signal used to control the drive capacity of the output circuit 19. The adjustment of the drive capacity of the output circuit 19 is a typical function of the data electrode driver circuit. In this embodiment, control data used to generate the three control signals: the data inversion signal INV, the shift direction control signal RL and the drive capacity adjustment signal PWRC are superposed on the polarity switching signal POL. This implies that three input terminals can be removed from the data electrode driver circuit 105.

In this embodiment, the decoder logic circuit 100 contains an inverter 109, a NAND gate 110, an inverter 111, a 3-bit counter 112, a D-flipflops 113, 114 and 115, an inverter delay element 116, a NAND gate 117 and an inverter 118.

The inverter 109, the NAND gate 110 and the inverter 111 forms a circuitry which extracts a portion of the polarity switching signal POL during a period in which the strobe signal STB is negated. As mentioned above, the control data are transferred over the polarity switching signal POL during the period in which the strobe signal STB is negated, and thus the inner signal POL_CLK outputted from the inverter 111 is a signal which contains the control data extracted from the polarity switching signal POL. The control data are encoded as the number of the pulses in the inner signal POL_CLK.

The 3-bit counter 112 counts the number of the pulses of the inner signal POL_CLK. The counter outputs Q0 to Q2 of the 3-bit counter 112 form the 3-bit data representing the number of the pulses of the inner signal POL_CLK. The D-flipflops 113, 114 and 115 latch the counter outputs Q0 to Q2 of the 3-bit counter 112, respectively. The output signals of the D-flipflops 113, 114 and 115 are used as the data inversion signal INV, the shift direction control signal RL and the drive capacity adjustment signal PWRC, respectively.

The inverter delay element 116, the NAND gate 117 and the inverter 118 form a circuitry which generates a reset signal RST_CT to reset the 3-bit counter 112. After the strobe signal STB is negated, the reset signal RST_CT is asserted with a delay corresponding to the delay time of the inverter delay element 116. The 3-bit counter 112 is reset in response to the assertion of the reset signal RST_CT. The delay time of the inverter delay element 116 is adjusted so that the reset signal RST_CT is asserted before the first pulse of the control data appears on the polarity switching signal POL after the strobe signal STB is negated. This allows resetting the 3-bit counter 112 before the number of the pulses of the inner signal POL_CLK is counted.

In the decoder logic circuit 100 thus configured, the data inversion signal INV, the shift direction control signal RL and the drive capacity adjustment signal PWRC can be set to desired values by selecting the number of the pulses incorporated into the polarity switching signal POL during the period in which the strobe signal STB is negated, from zero to seven. When the number of the pulses included in the polarity switching signal POL in the period in which the strobe signal STB is negated is set to six in a certain horizontal synchronization period, for example, the data inversion signal INV is set to the low level, and the shift direction control signal RL and the drive capacity adjustment signal PWRC are set to the high level.

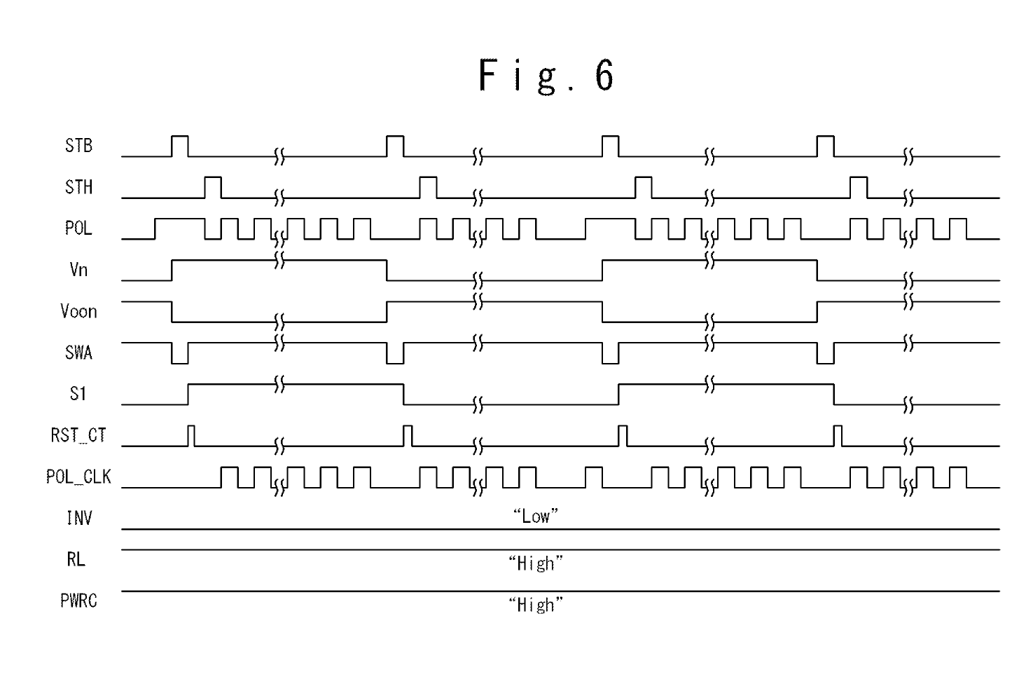

In the following, a detailed description is given of an exemplary operation of the data electrode driver circuit 105 of this embodiment. FIG. 6 is a timing chart showing an exemplary operation of the data electrode driver circuit 105 of this embodiment. It should be noted that, in FIG. 6, the symbol “Vn” denotes 64 analogue gray-level voltages Vn (n is an integer of 1 to 64) supplied from the gray-level voltage generator circuit 17. It should be also noted that the strobe signal STB1 is a signal generated by delaying the strobe signal STB supplied to the control circuit 15 from outside of the data electrode driver circuit 105 by a predetermined time, and the switch control signal SWA is a signal of the phase opposite to the strobe signal STB1. The data signal Sk (k is an integer of 1 to 528)) shown in FIG. 6 is a signal which is outputted to the data electrode from the output circuit 19 and has the same voltage level as the gray-level voltage selected by the gray-level voltage selector circuit 18. The following description is given with an assumption that the assertion of a signal is associated with the high level and the negation of the signal is associated with the low level.

The strobe signal STB is pulled up to the high level at the beginning of each horizontal synchronization period. The control circuit 15 in the data electrode driver circuit 105 determines the polarities of the data signals to be outputted to the respective data electrodes from the data electrode driver circuit 105, in response to the polarity of the polarity switching signal POL at the timing when the strobe signal STB is asserted (namely, when the strobe signal STB is pulled up). It should be noted here that the signal level of the polarity switching signal POL except the time period during which the strobe signal STB is pulled up has no relation to the polarities of the data signals outputted by the data electrode driver circuit 105. In this embodiment, as shown in FIG. 6, additional control data are encoded into the polarity switching signal POL by incorporating a desired number of pulses into the polarity switching signal POL during the period in which the strobe signal STB is set to the low level.

When the polarity switching signal POL and the strobe signal STB are supplied to the data electrode driver circuit 105 with the waveforms shown in FIG. 6, the inner signal POL_CLK is kept at the low level during the period in which the strobe signal STB is pulled up to the high level. In the period in which the strobe signal STB is set to the low level, on the other hand, the inner signal POL_CLK is generated to have the same waveform as the polarity switching signal POL, as shown in FIG. 6. This allows revealing the control data incorporated into the polarity switching signal POL as the waveform of the inner signal POL_CLK.

The inner signal POL_CLK is inputted to the 3-bit counter 112. The 3-bit counter 112 counts the number of the pulses of the inner signal POL_CLK to output 3-bit data corresponding to the counted number from the outputs Q0 to Q2 of the 3-bit counter 112. Here, the 3-bit counter 112 is reset by the reset signal RST_CT every horizontal synchronization period. The reset signal RST_CT is generated as a logical AND of a signal generated by inverting the strobe signal STB and a signal generated by delaying the strobe signal STB by the inverter delay element 116. The reset signal RST_CT is pulled up to the high level for a duration equal to the delay time of the inverter delay element 116 from the pull-down of the strobe signal STB, as shown in FIG. 6.

The data outputted from the outputs Q0 to Q2 of the 3-bit counter 112 are inputted to the D-flipflops 113 to 115, respectively. The D-flipflops 113 to 115 latch the input data in response to the pull-up of the strobe signal STB. The output signal of the D-flipflop 113 is supplied to the data buffer 13 and used as the data inversion signal INV. Also, the output signal of the D-flip-flop 114 is supplied to the shift register 12 and used as the shift direction control signal RL. Finally, the output signal of the D-flip-flop 115 is supplied to the output circuit 19 and used as the drive capacity adjustment signal PWRC.

For example, let us consider a case where six pulses are included in the inner signal POL_CLK in each horizontal synchronization period. In this case, the count value of the 3-bit counter 112 is set to six, and the outputs Q2 and Q1 are set to the high level, and the output Q0 is set to the low level. As a result, the data inversion signal INV is set to the low level, while the shift direction control signal RL and the drive capacity adjustment signal PWRC are set to the high level. Such operations are shown in FIG. 6.

As described above, the liquid crystal display apparatus of this embodiment is designed to incorporate control data into the polarity switching signal POL and to reproduce control signals from the control data in the data electrode driver circuit 105. This allows providing various advanced functions for the data electrode driver circuit 105 by using the control signals, without increasing the number of signals to be externally supplied to the data electrode driver circuit 105, that is, without increasing the number of input terminals of the data electrode driver circuit 105. The reduction in the number of the input terminals of the data electrode driver circuit 105 is effective for reducing the chip area of the data electrode driver circuit 105 and reducing the cost.

Although specific embodiments of the present invention are described above, the present invention may be implemented with changes or modifications which are apparent to the person skilled in the art. For example, although the above description is directed to a case when the present invention is applied to a liquid crystal display apparatus, the present invention may be applied to other display apparatuses which are configured to switch the polarities of the data signals in driving a display panel.

What is claimed is:

1. A display apparatus, comprising:
a display panel including a data electrode;
a display panel driver driving said data electrode by supplying a data signal to said data electrode; and
a controller supplying a polarity switching signal specifying a polarity of said data signal to said display panel driver,
wherein control data are incorporated into said polarity switching signal, and
wherein said display panel driver operates in responsive to said control data.

2. The display apparatus according to claim 1, wherein said display panel driver includes:
a logic circuit extracting said control data from said polarity switching signal and generating at least one control signal from said extracted control data; and
an internal circuit operating in response to said control signal.

3. The display apparatus according to claim 2, wherein said controller supplies first display data to said display panel driver,
wherein said internal circuit of said display panel driver includes a data buffer and a driver circuitry,
wherein said data buffer selects first data or second data as second display data and supplies said second display data to said driver circuitry, said first data being identical to said first display data and said second data being data obtained by inverting respective bits of said first display data,
wherein said driver circuitry generates said data signal in response to said polarity switching signal and said second display data, and
wherein said at least one control signal includes a data inversion signal indicating which of said first and second data are to be selected as said second display data.

4. The display apparatus according to claim 2, wherein said controller supplies display data and a horizontal start pulse signal to said display panel driver,
wherein said internal circuit of said display panel driver includes:
a shift register performing a shift operation for shifting said horizontal start pulse signal therein to successively output a plurality of sampling pulses;
a data register including a plurality of registers which respectively receive said display data in response to corresponding ones of said plurality of sampling pulses; and
a driver circuitry receiving said display data from said data register and generating said data signal in response to corresponding one of said display data received and said polarity switch signal,
wherein said control signal generated by said logic circuit includes a shift direction control signal specifying a direction of said shift operation in said shift register.

5. The display apparatus according to claim 2, wherein said internal circuit of said display panel driver includes an output circuit generating said data signal in response to said polarity switching signal, and
wherein said control signal generated by said logic circuit includes a drive capacity adjustment signal used to control a drive capacity of said output circuit.

6. The display apparatus according to claim 2, wherein said controller supplies a strobe signal to said display panel driver,
wherein said display panel driver includes:
an output circuit generating said data signal in response to said polarity switching signal; and
a control circuit determining a polarity of said data signal in response to a signal level of said polarity switching signal at a timing when said strobe signal is asserted,
wherein said logic circuit extracts said control data from said polarity switching signal during a period in which said strobe signal is negated.

7. The display apparatus according to claim 6, wherein said control data are incorporated into said polarity switching signal as a number of pulses during a period in which said strobe signal is negated, and
wherein said logic circuit generates said control signal in response to the number of pulses.

8. The display apparatus according to claim 1, wherein said display panel includes a liquid crystal display panel.

9. A display panel driver, comprising:
an output circuit receiving a polarity switching signal into which control data are incorporated and supplying a data signal of a polarity specified by said polarity switching signal to a data electrode of a display panel;
a logic circuit extracting said control data from said polarity switching signal and generating a control signal from said extracted control data; and
an internal circuit operating in response to said control signal.

10. A display panel driving method, comprising:
supplying a polarity switching signal into which control data are incorporated, to a display panel driver;
driving a data electrode of a display panel by an output circuit of said display panel driver, through supplying a data signal of a polarity specified by said polarity switching signal to said data electrode;
extracting said control data from said polarity switching signal; and
controlling an internal circuit within said display panel driver in response to said control data.
